(19) United States
(12) Patent Application Publication
(10) Pub. No.: US 2026/0350779 A1
(43) Pub. Date: Nov. 5, 2026

(54) VISION INSPECTION SYSTEM AND METHOD USING MOBILE ROBOT

(71) Applicants: Hyundai Motor Company, Seoul (KR); Kia Corporation, Seoul (KR)

(72) Inventor: Changmo YANG, Gyeonggi-do (KR)

(21) Appl. No.: 19/118,640

(22) PCT Filed: Jun. 15, 2023
(86) PCT No.: PCT/KR2023/008297

§ 371 Date: Apr. 4, 2025

(30) Foreign Application Priority Data
Oct. 4, 2022 (KR) 10-2022-0126235

(51) Int. Cl. G06T 7/00; G05D 1/617; G05D 1/689; G05D 105/80; G06T 7/70

(52) U.S. Cl. CPC G06T 7/001; G05D 1/617; G05D 1/6895; G06T 7/70; G05D 2105/80; G06T 2207/20081; G06T 2207/30108; G06T 2207/30196

(57) ABSTRACT

A vision inspection system may include a mobile robot configured to move to at least one designated inspection position P and photograph an inspection region of a component part assembled with a product, and an inspection server configured to obtain an inspection image photographed from the mobile robot, calculate an image deviation of the inspection image compared to a reference image reflecting repeated positional errors of the robot with respect to respective inspection positions, and evaluate an assembly quality of the inspection image for each inspection position through an inspection algorithm learned by performing an image augmentation reflecting a range of the image deviation.

### CROSS-REFERENCE TO RELATED APPLICATIONS

This application is the U.S. National Phase under 35 U.S.C. § 371 of International Patent Application No. PCT/KR 2023/008297, filed on Jun. 15, 2023, which in turn claims the benefit of Korean Application No. 10-2022-0126235, filed on Oct. 4, 2022, the entire disclosures of which applications are incorporated by reference herein.

### TECHNICAL FIELD

The present disclosure relates to a vision inspection system and method, and more particularly, the present disclosure relates to a vision inspection system and a method thereof, for inspecting manual assembly quality of a worker in real time in a vehicle assembly process.

### BACKGROUND ART

Typically, automobile manufacturing plants assemble car bodies and component parts through a variety of processes, and in the manual assembly process by workers, real-time quality inspection is required to ensure product quality.

Conventional real-time quality inspection uses a camera mounted on an articulated, fixed robot to capture inspection images to perform vision inspection. However, conventional vision inspection methods have limitations in the control of the photographing posture (motion) and the photographing area of a fixed robot, so multiple robots must be operated, and the work paths of workers and robots overlap, which hinders work or poses a risk of collision.

Accordingly, recently, methods are being explored to mount cameras on mobile robots and take inspection images without interfering with the worker's work path. However, when utilizing a mobile robot, there is a problem in that image deviation occurs repeatedly each time an image is acquired due to positional errors (photographing deviations) when the camera is photographing, which leads to a deterioration in vision inspection performance.

For example, even if a mobile robot is set to photograph the inspection region of a vehicle from a designated inspection position, due to its movable nature, there is a deviation between the inspection images taken each time due to minutely repeated positional errors of the mobile robot. Additionally, the positional error of these robots causes a deviation between the reference image of the component part set for assembly quality inspection and the inspection image.

The deviation of inspection images using these mobile robots causes performance degradation in quality inspection of vision inspection systems, so improvement measures are needed to improve inspection performance.

The above information disclosed in this Background section is only for enhancement of understanding of the background of the disclosure, and therefore it may contain information that does not form the prior art that is already known in this country to a person of ordinary skill in the art.

### DISCLOSURE

### Technical Problem

The present disclosure attempts to provide a vision inspection system and a method thereof, capable of automatically calculating image deviation reflecting repeated positional errors of the robot and performing vision inspection for each inspection component part by constructing an inspection algorithm reflecting the same, when performing a vision inspection utilizing a mobile robot in an industrial site.

The present disclosure also attempts to provide a vision inspection system capable of maintaining an optimal inspection quality in real time by automatically replacing the existing inspection algorithm with a new inspection algorithm generated by automatically designating an augmentation range reflecting an image deviation due to various environmental changes.

### Technical Solution

A vision inspection system utilizing a vision sensor configured to move to at least one designated inspection position P and photograph an inspection region of a component part assembled with a product, may include an inspection server configured to obtain an inspection image photographed from the mobile robot, calculate an image deviation of the inspection image compared to a reference image reflecting repeated positional errors of the robot with respect to respective inspection positions, and evaluate an assembly quality of the inspection image for each inspection position through an inspection algorithm learned by performing an image augmentation reflecting a range of the image deviation.

The mobile robot may include a vision sensor module configured to generate the inspection image photographed at the inspection position, an autonomous driving sensor module configured to detect surroundings through sensors, a mobile module configured to freely move through drive wheels or quadruped walking, a wireless communication module configured to transmit the photographed inspection image to the inspection server through a wireless communication, and a control module configured to perform a control to recognize a position of a worker the vision sensor module, follow the worker to move to the inspection position P where the work has been completed, and photograph the inspection image through the vision sensor module.

The control module may store at least one inspection position designated for an assembling position of the component part to be assembled in a corresponding process depending on a type and specifications of the product and photographing an inspection image.

The control module may be configured to distinguish a plurality of zones circumferentially partitioned around the product, and restrict movement so as not to enter a worker zone where the worker is currently present.

The vision sensor module may be mounted on the mobile robot through a robot arm, and configured to photograph the inspection image of an exterior component part and an interior component part of the product through a motion control of the robot arm.

The inspection server may include a communication unit configured to obtain the inspection image from the mobile robot, an image processing unit configured to store the reference image corresponding to the inspection image for each component part and generate a correction image converted by match-processing the inspection image by comparison with the reference image, a deep-learning learning unit configured to construct the inspection algorithm for each inspection component part of a corresponding process by learning the inspection position of a repeated positional error range with respect to each mobile robot by deep-learning through the image augmentation with respect to the inspection image in advance, a database (DB) configured to store a program and data for operating the inspection server, and a controller configured to generate a new inspection algorithm by designating an image augmentation range for the deep-learning learning based on a transformation matrix obtained by the image matching processing process.

The image processing unit may be configured to extract a transformation matrix information that can be obtained when correcting the inspection image by calculating an image matching error of the inspection image with respect to the reference image and calculating the image deviation between two images at the image matching processing.

The transformation matrix information may include information on Translation for image moving the image, Rotation for image rotation, Scale for image enlargement/reduction, Tilt for image slope conversion and Shear for image shearing, as values for quantifying the image deviation.

The image processing unit may be configured to extract at least one inspection component part image corresponding to a region of inspection component part (ROI) set for the reference image in the correction image as learning data.

The deep-learning learning unit may be configured to perform the image augmentation using a transformation matrix range and the inspection component part image extracted by the image processing unit and augment a learning image of the corresponding inspection component part to which the repeated positional error range is reflected.

The deep-learning learning unit may be configured to learn the inspection component part image by deep-learning through the inspection algorithm of a corresponding component part, and output one inspection result among good (OK), defective (NG), and inspection error (NA).

The controller may be configured to generate the new inspection algorithm reflecting an image augmentation range for the deep-learning learning in real time based on a transformation matrix information obtained by an image matching processing process of an inspection image.

The controller may be configured to replace or update the existing inspection algorithm with the new inspection algorithm when it is determined that the performance has been improved by comparing an inspection result learned again by deep-learning using the new inspection algorithm with an inspection result obtained by using an existing inspection algorithm.

A vision inspection method for inspecting manual assembly quality of a worker in real time in a vehicle assembly process, the vision inspection method includes obtaining a photographed inspection image at a specific inspection position where an inspection around a product vehicle is required by using the mobile robot, extract an inspection component part image from a correction image converted from the inspection image by image matching processing to match a preset reference image, automatically calculate an image deviation of the inspection image compared to the reference image reflecting repeated positional errors of the robot with respect to respective inspection positions, storing an inspection algorithm learned by performing an image augmentation reflecting a range of the image deviation, and performing the vision inspection by a deep-learning learning using the inspection algorithm for the inspection component part corresponding to the inspection component part image, and obtaining one inspection result among good (OK), defective (NG), and inspection error (NA) according to the vision inspection.

The obtaining the inspection result further include extracting images that are falsely inspected or cannot be judged through confirmation of an operator on the inspection result, and storing the extracted images as evaluation data for confirming the performance of a new inspection algorithm, when the inspection result is determined to be defective (NG) or inspection error (NA).

The extracting the inspection component part image may further include generating the new inspection algorithm by designating an image augmentation range for the deep-learning learning based on a transformation matrix obtained by an image matching processing process.

The generate the new inspection algorithm may include calculating an image matching error of the inspection image with respect to the reference image, extracting the transformation matrix that can be obtained when correcting the inspection image, by calculating the image deviation between two images, calculate a distribution of transformation matrix values extracted corresponding to the inspection position and store a range in a DB, designating a transformation matrix range for the image augmentation at the deep-learning learning of the corresponding inspection component part image based on a repeated positional error range stored in the DB, and deep-learning learning a plurality of learning images augmented be the augmentation in which the repeated positional error of the mobile robot is reflected, generating the new inspection algorithm of a corresponding component part, and re-learning the inspection component part image through deep-learning.

The designating the matrix range may designate a range at random number generation of conversion values of the Translation, the Rotation, the Scale, the Tilt, and the Shear of the inspection component part image by using the augmentation at the deep-learning learning based on the repeated positional error range of the transformation matrix.

The designating the matrix range may perform the deep-learning learning by generating a random number according to a Gaussian normal distribution and assigning a weight value to the image deviation having a high possibility based on repeated error of the mobile robot depending on positions.

A vision inspection method may further include, after the re-learning by the deep-learning, replacing or updating an existing inspection algorithm with the new inspection algorithm, when it is determined that the performance is improved by comparing the re-learned result with the evaluation data.

### Advantageous Effects

According to an embodiment, when performing a vision inspection utilizing a mobile robot, by automatically calculate image deviation reflecting repeated positional errors of the mobile robot and performing the vision inspection by generating an inspection algorithm reflecting the same, the inspection performance may be improved with respect to the repeated positional error of the mobile robot.

In addition, while performing the vision inspection, by generating a new inspection algorithm by designating an augmentation range reflecting an image deviation due to aging of the equipment over time or various environmental changes, and replacing/updating the existing inspection algorithm with the same, degradation of inspection performance can be prevented, and an optimal inspection quality in real time can be maintained.

In addition, the mobile robot can perform vision inspections following the worker and limit its movement so that it does not enter the zone where the worker is currently present, thereby preventing collisions without interfering with the worker's work path.

### Description of the Drawings

FIG. 1 shows a vision inspection system applied to a product assembly process according to an embodiment.

FIG. 2 is a block diagram schematically showing a configuration of a vision inspection system according to an embodiment.

FIG. 3 is a drawing for explaining the problem of image deviation occurring during vision inspection according to an embodiment.

FIG. 4 represents an inspection image processing method for a vision inspection according to an embodiment.

FIG. 5 represents a transformation matrix according to an embodiment.

FIG. 6 represents a method for constructing an inspection algorithm for each inspection component part according to an embodiment.

FIG. 7 represents a vision inspection method using an inspection algorithm for each inspection component part according to an embodiment.

FIG. 8 is a flowchart schematically showing a vision inspection method using a mobile robot according to an embodiment.

### MODE FOR INVENTION

The present disclosure will be described more fully hereinafter with reference to the accompanying drawings, in which exemplary embodiments of the disclosure are shown.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any one or all combinations of one or more related items.

Throughout the specification, terms such as first, second, “A”, “B”, “(a)”, “(b)”, and the like will be used only to describe various elements, and are not to be interpreted as limiting these elements. These terms are only for distinguishing the constituent elements from other constituent elements, and nature or order of the constituent elements is not limited by the term.

In this specification, it is to be understood that when one component is referred to as being “connected” or “coupled” to another component, it may be connected or coupled directly to the other component or be connected or coupled to the other component with a further component intervening therebetween. In this specification, it is to be understood that when one component is referred to as being “connected or coupled directly” to another component, it may be connected to or coupled to the other component without another component intervening therebetween.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. The controller may control operation of units, modules, parts, devices, or the like, as described herein. Moreover, it is understood that the below methods may be executed by an apparatus comprising the controller in conjunction with one or more other components, as would be appreciated by a person of ordinary skill in the art.

In addition, various terms related to “image” are used throughout the specification, which are defined as follows.

The term inspection image may mean an original image obtained as a mobile robot photographs an inspection region at specific inspection positions (e.g., P1, P2, . . . , Pn) at the time of an actual vision inspection.

The term reference image is an optimal image obtained by photographing the inspection region after moving the mobile robot to inspection positions EX. P1, P2, . . . , and Pn designated in advance, and may become a reference for evaluating an assembly quality for respective component parts belonging to the inspection image at the time of the vision inspection.

The term a correction image may mean an image converted close (similar) to the reference image by compensating a deviation of the inspection image with respect to the reference image.

An inspection component part image may mean an individual component part image extracted from the correction image corresponding to regions of inspection component part ROI set in the reference image.

A learning image may mean a deep-learning training data set that has been augmented by converting the inspection component part image by an image augmentation.

Now, a vision inspection system utilizing the mobile robot and a method thereof according to an embodiment will be described in detail with reference to the drawings.

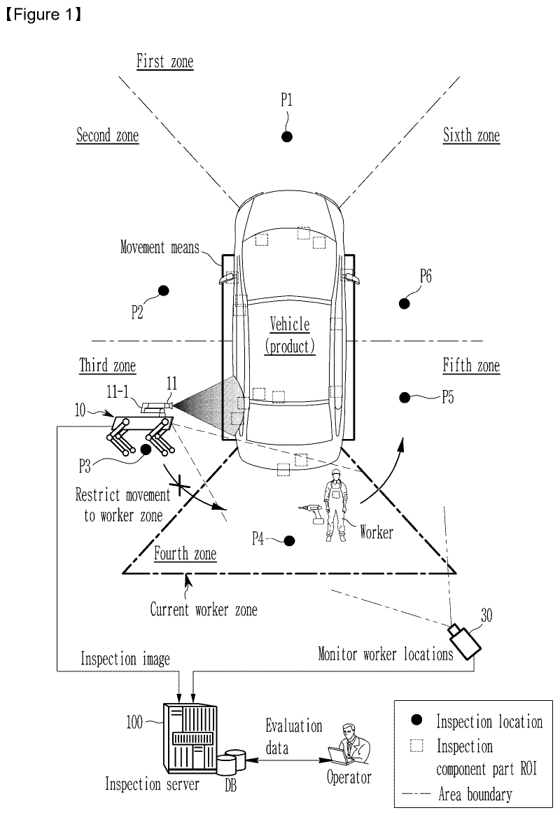

FIG. 1 shows a vision inspection system utilizing the mobile robot applied to a product assembly process according to an embodiment.

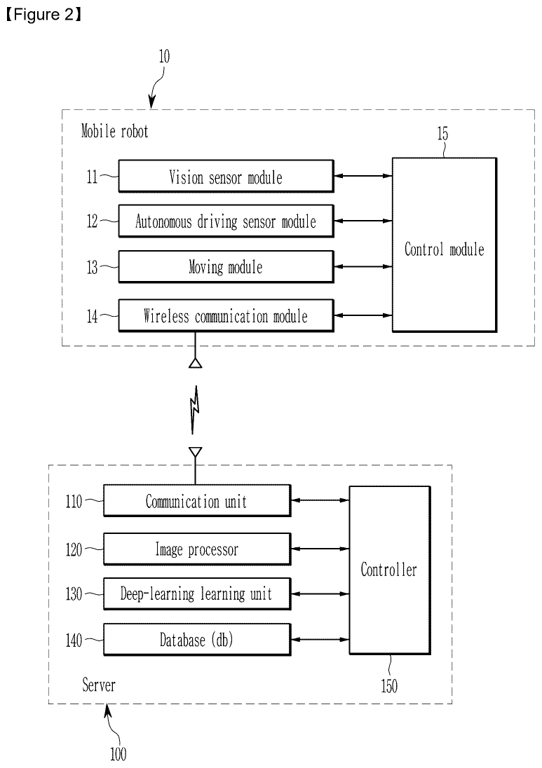

FIG. 2 is a block diagram schematically showing a configuration of a vision inspection system utilizing the mobile robot according to an embodiment. Referring to FIG. 1 and FIG. 2, an inspection server 100 according to an embodiment is to evaluate a component part assembly quality of a worker in a product assembly process of an industrial site, may include the mobile robot 10 configured to move to at least one designated inspection position P and photograph an inspection region of a component part assembled with a product, and may be configured to obtain the inspection image photographed from the mobile robot 10, automatically calculate image deviation of the inspection image compared to reference image reflecting repeated positional errors of the robot with respect to respective inspection positions, and evaluate the assembly quality of the inspection image for each inspection position through an inspection algorithm learned by performing an Image augmentation reflecting a range of the image deviation.

Here, the product is transported to a predetermined work position through a transport means 20 of a smart factory, and at least one component part allocated to the worker is assembled. Hereinafter, the product is assumed to be “a vehicle”, and the vehicle may be a vehicle body in an assembly process or components parts (e.g., doors, dashboards, interior parts, or the like) for the vehicle body. The transport means 20 may be a conveyor, a logistics transport robot, or the like.

The mobile robot 10 may move to the designated inspection position P and transmit the photographed inspection image to the inspection server 100. Here, the inspection position P may be photographing position/location existing in a plurality of work zones (e.g., first zone to sixth zone) circumferentially partitioned around the vehicle, and for example, may include a first inspection position P1, a second inspection position P2, . . . , a sixth inspection position P6, designated for the plurality of work zones, respectively. However, the number of work zones and the inspection positions of an embodiment is not limited thereto, and depending on assembling positions of the component part, a plurality of inspection positions may be designated in the same work zone.

The mobile robot 10 may be configured as a quadruped walking robot, an autonomous mobile robot (AMR), or the like. The AMR is limited to move only on a flat bottom by using drive wheels, a preferable embodiment of the present disclosure will be described assuming a quadruped walking robot (also called “robot dog” or “spot”) that can move on stairs or uneven rough surfaces with a higher degree of freedom.

As shown in FIG. 2, the mobile robot 10 may include a vision sensor module 11, an autonomous driving sensor module 12, a mobile module 13, a wireless communication module 14 and a control module 15.

The vision sensor module 11 may be mounted on the robot, and may generate the inspection image photographed at the designated inspection position P.

The vision sensor module 11 may be mounted on the mobile robot 10 through a robot arm 11-1 for the degree of freedom of changing the photographing position. The vision sensor module 11 may photograph not only an exterior component part of the vehicle but also an interior component part within the vehicle by using motion control of the robot arm 11-1.

The autonomous driving sensor module 12 may include at least one sensor among a camera, a laser, an ultrasonic wave, a radar, a lidar and a position recognition apparatus for autonomous driving, to detect surroundings and recognize the worker and objects.

The mobile module 13 may include four legs, and may freely move on stairs or uneven surfaces through quadruped walking.

The wireless communication module 14 may transmit the inspection image photographed by the vision sensor module 11 to the inspection server 100 through a wireless communication, and when needed, may receive control signals from the inspection server 100.

The control module 15 may control an overall operation for operating the mobile robot 10 according to an embodiment.

When the vehicle is transport to the work position, the worker may assemble at least one component part allocated to the worker to the vehicle. The component part may be the vehicle body, parts, electrical component, or the like, to be assembled to the vehicle, or may include fastening part, or the like, such as bolts, nuts, rivets, or the like, having designated assembling positions. The control module 15 may store assembling positions of the component part to be assembled in the corresponding process, and at least one inspection position P1 and P2, . . . , and P6 designated for photographing the inspection image, depending on the types and specifications of the vehicle.

The control module 15 may perform a control to recognize a position of the worker the vision sensor module 11, follow the worker to move to the inspection positions P1 and P2, . . . , and P6 where the work has been completed, and photograph the inspection image through the vision sensor module 11.

For example, as shown in FIG. 1, when the worker is working in the fourth zone after completing the work in the first zone, the second zone, and the third zone, the mobile robot 10 may move in the order of P1, P2, and P3, and may wait after photographing the inspection image.

At this time, the control module 15 may restrict the movement of the mobile robot 10 so as not to enter a worker zone where the worker is currently present (i.e., the fourth zone) and to wait, thereby preventing a potential collision without causing interference with the work path of the worker.

In addition, for safety of the worker, a surveillance camera 30 configured to monitor the position of the worker and transmit the entering event of the mobile robot 10 into the worker zone to the inspection server 100 may be further configured in the assembly process region.

The inspection server 100 may immediately transfer the stop signal to the mobile robot 10 upon receiving the entering event, to restrict the movement to the worker zone, thereby ensuring the safety of the worker.

Meanwhile, when the inspection image is obtained from the mobile robot 10, the inspection server 100 may detect feature points to perform the image conversion to be close to the reference image, and inspect at least one inspection component part image extracted by cropping a region of inspection component part (Region of Interest, ROI) through a deep-learning vision inspection program.

However, when the vision inspection is performed by using the mobile robot 10, there is a problem in that, in the inspection image obtained according to a position of the mobile robot 10 and the position of the inspection component part, an image deviation is generated with respect to reference image due to the positional error occurring at photographing.

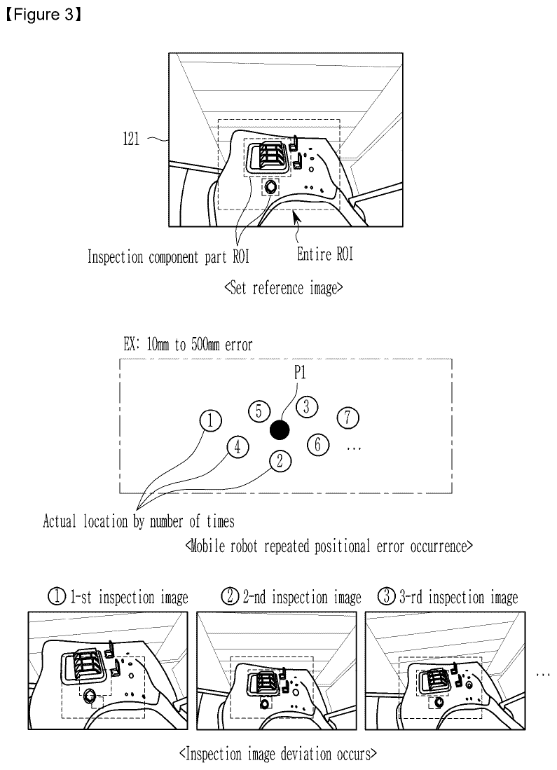

For example, FIG. 3 is a drawing for explaining the problem of image deviation occurring during the vision inspection utilizing the mobile robot according to an embodiment.

Referring to FIG. 3, a reference image 121 is an optimal image obtained by photographing the inspection region after the mobile robot 10 is positioned at the first inspection position P1 in advance.

The reference image 121 may become a reference of the vision inspection for evaluating the assembly quality of the component part belonging to the corresponding inspection image, and at least one inspection component part ROI region and an entire ROI region including them may be set.

However, since the mobile robot 10 is a mobile equipment, unlike the existing fixed equipment, even if it is set to move to the designated inspection positions P1 and P2, . . . , and P6 to photograph the inspection region of the vehicle body, the deviation of the photographed inspection image is caused each time due to minutely repeated positional errors (hereinafter, referred to as “repeated positional error”), thereby deteriorating the inspection performance.

That is, as shown in FIG. 3, every time when the mobile robot 10 moves to the first inspection position P1 and obtain the inspection image, large or small (e.g., 10 mm to 500 mm) repeated positional error may occur.

Accordingly, when the mobile robot 10 has performed photographing at actual locations by number of inspection times, image deviations departing from the reference image 121 may occur in a 1-st inspection image, a 2-nd inspection image, a 3-rd inspection image, or the like. Here, when the mobile robot 10 is used by being attached with the robot arm 11-1 for the degree of freedom in image photographing, according to the repeated positional error and the positional error of the robot arm 11-1, the deviation of the photographed inspection image may further increase.

As such, in the inspection image obtained from the mobile robot 10, the image deviation may occur due to the repeated positional error of the robot, and this may be understood as the translation, rotation, scale, tilt, and shear of the image generated by the repeated positional error being reflected to the image deviation.

In consideration of these issues, when performing the vision inspection by utilizing the mobile robot 10, the image conversion condition may be repeatedly changed due to the repeated positional error of the robot when compensating the image deviation of the obtained inspection image, the inspection server 100 has to generate the inspection algorithm reflecting the repeated positional error of the robot with respect to components parts of the respective inspection positions P.

Thus, the inspection server 100 according to an embodiment attempts to automatically generate the inspection algorithm through a deep-learning learning of reflecting the image deviation ranges (repeated positional error) of the robot with respect to the component parts of the respective inspection positions P of the mobile robot 10.

For such a purpose, the inspection server 100 may generate the inspection algorithm by performing the image augmentation reflecting a repeated positional error range of the mobile robot 10 when performing the deep-learning learning, and may improve the inspection performance by performing the vision inspection through the inspection algorithm in consideration of the repeated positional error of the mobile robot 10.

The inspection server 100 may include a communication unit 110, an image processing unit 120, a deep-learning learning unit 130, a database (DB) 140, and a controller 150.

The communication unit 110 may include a wired/wireless communication means, and may obtain the inspection image from the mobile robot 10.

The image processing unit 120 may store the reference image corresponding to the inspection image with respect to each component part, and may generate the correction image converted by match-processing the obtained inspection image by comparison with the corresponding reference image.

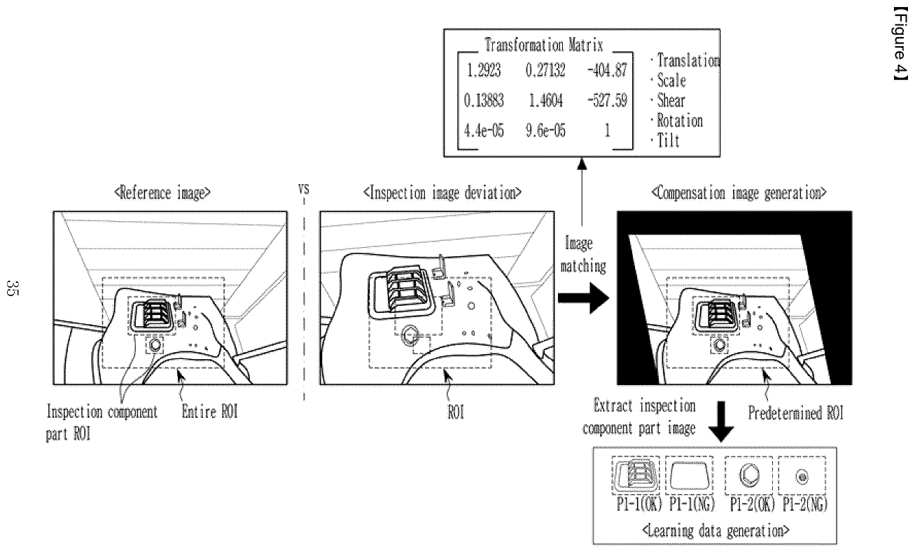

FIG. 4 represents the inspection image processing method for a vision inspection according to an embodiment.

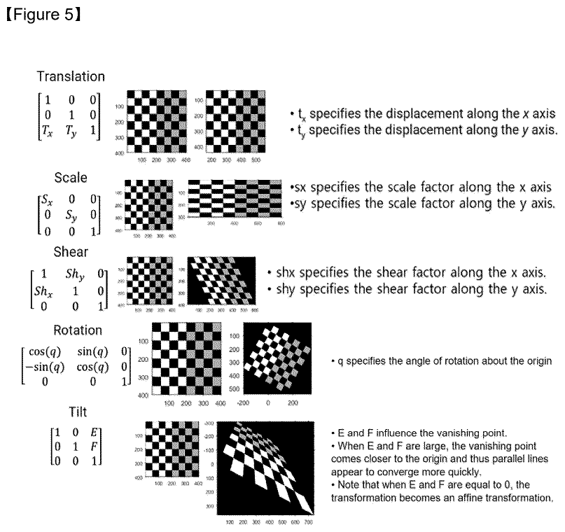

FIG. 5 represents a transformation matrix according to an embodiment. Referring to FIG. 4 and FIG. 5, the image processing unit 120 may extract a transformation matrix information that can be obtained when correcting the inspection image by calculating an image matching error of the inspection image with respect to the reference image and calculating the image deviation between two images at the image matching processing. Here, the transformation matrix information may include information on Translation for image moving the image, Rotation for image rotation, Scale for image enlargement/reduction, Tilt for image slope conversion and Shear for image shearing, as values for quantifying the image deviation.

The image processing unit 120 may extract at least one inspection component part image corresponding to a region of inspection component part (ROI) set for the reference image in the correction image as learning data.

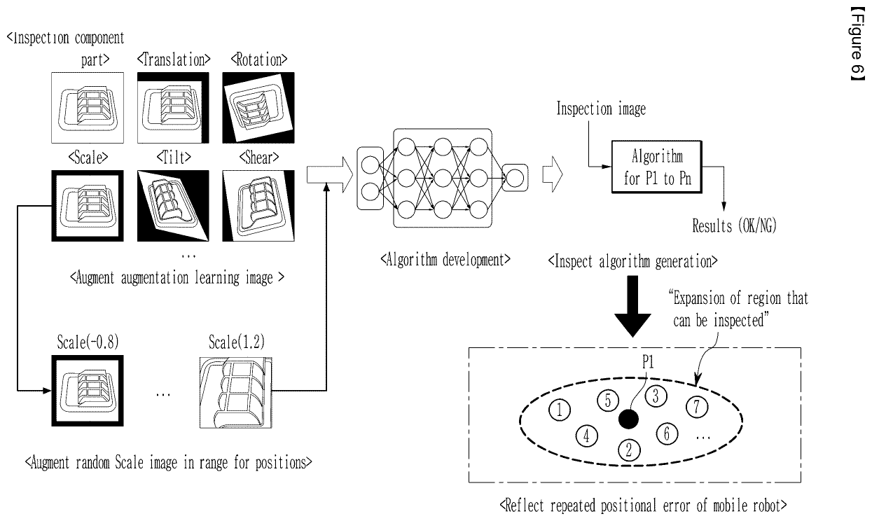

Meanwhile, FIG. 6 represents a method for constructing the inspection algorithm for each inspection component part according to an embodiment.

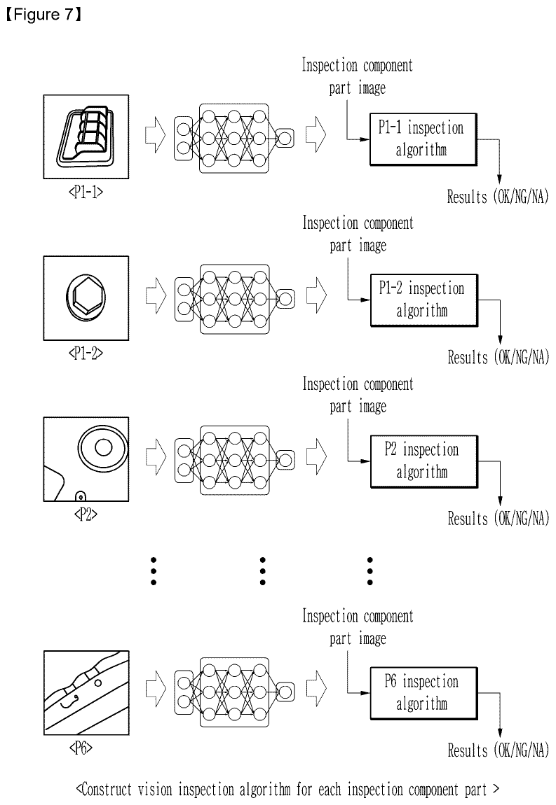

FIG. 7 represents a vision inspection method using the inspection algorithm for each inspection component part according to an embodiment.

Referring to FIG. 6 and FIG. 7, the deep-learning learning unit 130 may train the repeated positional error range for respective the inspection positions P1, P2, . . . , and P6 of the mobile robot 10 through the image augmentation with respect to the inspection image in advance, and construct the inspection algorithm for respective inspection component parts P1-1, P1-2, P2, . . . , and P6 of the corresponding process.

At this time, the deep-learning learning unit 130 may perform the image augmentation using the transformation matrix range and the inspection component part image extracted by the image processing unit 120, and thereby augment the learning image of the corresponding inspection component part reflecting the repeated positional error range of the robot. Depending on the transformation matrix range, a range at random number generation of conversion values of the Translation, the Rotation, the Scale, the Tilt, and the Shear of the image may be designated to the learning image. Here, the image augmentation may be performed to a plurality of inspection component part images included in one inspection image, by equally applying the transformation matrix range.

In addition, the deep-learning learning unit 130 may augment random scale image to which the repeated positional error range of the robot is reflected and apply it to the learning image.

As such, by generating the inspection algorithm through augmentation of the various learning images reflecting the repeated positional error range of the robot with respect to the designated inspection position, the mobile robot may expand a region that can be inspected, around the inspection position. Therefore, even if the repeated positional error of the mobile robot occurs within the region that can be inspected, the inspection error may be prevented and the inspection performance may be improved.

The deep-learning learning unit 130 may learn the inspection component part image by deep-learning through the inspection algorithm of a corresponding component part, and output one inspection result among good (OK), defective (NG), and inspection error (NA).

For example, in response to an input of a P1-1 inspection component part image, the deep-learning learning unit 130 may perform the vision inspection through a corresponding P1-1 algorithm, and output the inspection result.

Here, the inspection result may be determined based on the similarity ratio (%) of the P1-1 inspection component part image being close to a good product reference image P1-1(OK) in which the corresponding component part is normally assembled or to a defect reference image P1-1(NG) in which the component part is not assembled. However, when the P1-1 inspection component part image is close to none of the good product reference image P1-1(OK) and the defect reference image P1-1(NG), it may output the inspection error (NA), which means the decision is impossible.

In addition, the deep-learning learning unit 130 may determine whether it is good/defective (OK/NG) based on a condition whether the first inspection component part image P1-1 matched a good product reference image (P1-1(OK)) by a predetermined ratio (e.g., 80%) or more or less condition.

The deep-learning learning unit 130 may be configured as an artificial neural network-based program.

A DB 140 may store various programs and data required for an operation of the inspection server 100 utilizing the mobile robot according to an embodiment, and may store data generated according to its operation.

The DB 140 may store the inspection algorithm for the respective inspection component parts P1-1, P1-2, P2, . . . , and P6 corresponding to a corresponding process, and may replace or additionally update the inspection algorithm newly generated while repeating the vision inspection.

The controller 150 may be a central processing unit configured to control an overall operation of the inspection server 100 that performs the vision inspection utilizing the mobile robot according to an embodiment. That is, the controller 150 may control respective parts configured in the server 100 by executing various programs stored in the DB 140.

The controller 150 may be implemented with one or more processors that operate according to a set program, and the set program may be programmed to perform each step of the battery cell classification method according to an embodiment.

The vision inspection method using the mobile robot will be hereinafter described in more detail with reference to the drawings.

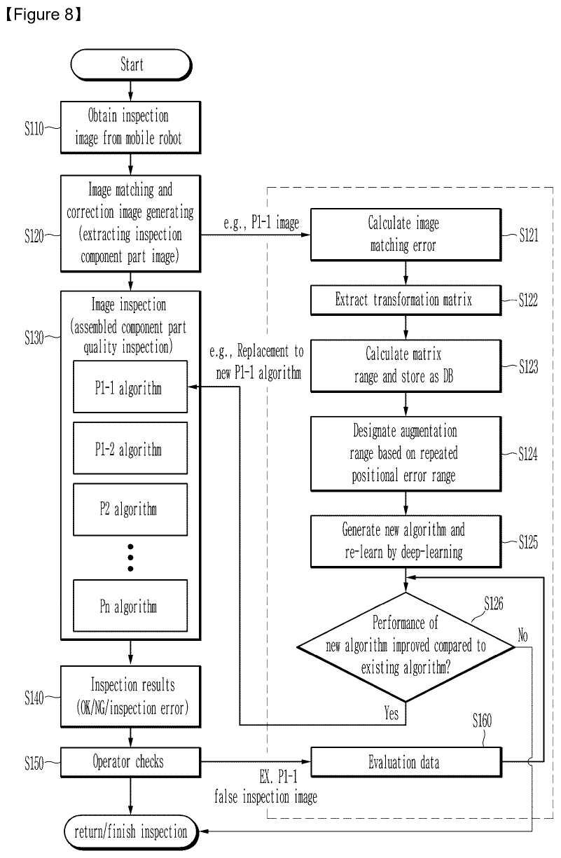

FIG. 8 is a flowchart schematically showing a vision inspection method using the mobile robot according to an embodiment.

Referring to FIG. 8, as have been described above with reference to FIG. 1, a vision inspection method using the mobile robot according to an embodiment will be described in the scenario in which, for the vision inspection of a manual assembly process of the component part, the mobile robot 10 under operation moves to the first inspection position P1 to the sixth inspection position P6 designated around a product vehicle and photographs the inspection image of the component part assembled with the vehicle.

At step S110, the controller 150 of the inspection server 100 may obtain the inspection image photographed by the specific inspection position requiring the inspection around the product vehicle by using the mobile robot 10 under operation. Hereinbelow, for better understanding and ease of description, it is assumed that the controller 150 obtains the inspection image photographed by the first inspection position P1 from the mobile robot 10.

The controller 150 may generate the correction image that is converted by performing an image matching processing to the inspection image obtained from the mobile robot 10 to match the region of inspection component part (ROI) of a preset reference image. In addition, at step S120, at least one inspection component part image corresponding to the region of inspection component part (ROI) of the reference image is extracted from the correction image. For example, the inspection component part image has a component part number P1-1 corresponding to the first inspection position P1, and through this, may identify the inspection component part P1-1, which is an object of the vision inspection.

The controller 150 automatically has calculated an image deviation of the inspection image compared to reference image reflecting the repeated positional errors of the robot with respect to respective inspection positions, in advance, and has constructed an inspection algorithm for assembled component part P1-1, P1-2, P2, . . . , and P6 of the corresponding process learned through deep-learning by performing an automatic image augmentation reflecting a range of the image deviation.

At step S130, the controller 150 performs the vision inspection through deep-learning learning using an inspection algorithm for a first inspection component part P1-1 corresponding to the first inspection component part image P1-1.

At step S140, the controller 150 may obtain one inspection result among good (OK), defective (NG), and inspection error (NA) according to the vision inspection.

At this time, when the inspection result is determined as good (OK), the controller 150 may terminate the corresponding inspection and return to repeat the vision inspection with respect to a subsequent component part inspection image P1-2, P2, . . . , and P6, and when the inspection image of the subsequent component part does not exist, the inspection may be terminated.

On the other hand, when the inspection result is determined as defective (NG) or inspection error (NA), the controller 150 may extract images that are falsely inspected (e.g., false decision between OK and NG) or cannot be judged through confirmation of an operator on the inspection result to store them, and use them as evaluation data for confirming the performance of a new inspection algorithm described later, at step S160.

As such, the controller 150 may learn the repeated error range for each the inspection position of the mobile robot 10 in advance, to construct the inspection algorithm for component parts P1-1, P1-2, P2, . . . , P6, and perform the vision inspection utilizing this, through which an image deviation with respect to the repeated positional error of the mobile robot 10 may be compensated and thereby the evaluation performance of the assembly quality for respective component parts may be improved.

Meanwhile, in the pre-constructed inspection algorithm (hereinafter, referred to as “an existing inspection algorithm”), the image deviation may be caused by various environmental change of process operations such as aging of the process equipments including the mobile robot 10 or a change of a mounting position of the vision sensor module 11 according to the flow of time, and due to this, the inspection performance may be deteriorated.

Therefore, in order to prevent degradation of inspection performance, the controller 150 is featured to generate the new inspection algorithm in which the image augmentation range for the deep-learning learning in real time is optimized based on the transformation matrix information obtained by the image matching processing process of the S120 step.

Through this, by replacing or additionally updating the existing inspection algorithm with the new inspection algorithm reflecting the various environmental change, the performance degradation of the inspection algorithm due to not only the repeated positional error of the mobile robot but also various environmental changes such as the aging of the equipment may be prevented, and furthermore, the inspection performance may be further improved.

Hereinafter, a generation method of the new inspection algorithm with respect to respective component parts according to an embodiment will be described in detail.

At step S121, the controller 150 calculates the image matching error of the inspection image with respect to the reference image, in the image matching processing process. In addition, at step S122, calculate the image deviation between two images, and extract the transformation matrix that can be obtained when correcting the inspection image. Here, the transformation matrix may include information on Translation for image moving the image, Rotation for image rotation, Scale for image enlargement/reduction, Tilt for image slope conversion and Shear for image shearing, as values for quantifying the image deviation.

At step S123, the controller 150 calculates a distribution of the transformation matrix values extracted corresponding to the inspection (photographing) position of the mobile robot 10 and form a DB of the range to store it in the DB 140.

At step S124, the controller 150 designate the transformation matrix range for the image augmentation during the deep-learning learning of the corresponding inspection component part image based on the repeated positional error range stored in the DB 140. That is, the controller 150 may designate a range at random number generate of the conversion values of the Translation, the Rotation, the Scale, the Tilt, and the Shear of the inspection component part image by using the augmentation at the deep-learning learning based on the repeated positional error range of the transformation matrix. In particular, the controller 150 may generate random numbers according to a Gaussian normal distribution when designating the transformation matrix range, and may perform the deep-learning learning by assigning more a weight value to the image deviation having high possibility of generating repeated error of the mobile robot depending on positions.

At step S125, the controller 150 may generate the new inspection algorithm of the corresponding component part by deep-learning learning a plurality of learning images augmented be the augmentation in which the repeated positional error of the mobile robot 10 is reflected, and may re-learn the inspection component part image by deep-learning by utilizing the new inspection algorithm.

That is, in performing the deep-learning learning, the controller 150 may generate the new inspection algorithm with respect to each component part through the image augmentation reflecting error ranges with respect to respective positions of the mobile robot 10, and through the deep-learning re-learning utilizing this, the inspection performance may be improved.

At step S126, the controller 150 compares the evaluation data of the existing inspection algorithm provided for the performance evaluation of and the new inspection algorithm and the re-learning inspection result.

At this time, when the evaluation performance of the new inspection algorithm is improved than the existing inspection algorithm constructed in advance (e.g., existing the P1-1 algorithm<new the P1-1 algorithm) (S126—Yes), the controller 150 automatically replaces the existing inspection algorithm with the new algorithm. For example, in the case that an image where an inspection error (NA) has occurred by utilizing the existing inspection algorithm can be judged to be either good (OK) or defective (NG) by utilizing the new inspection algorithm, it is determined that the evaluation performance is improved, and the algorithm may be automatically replaced.

On the other hand, when the evaluation performance is not improved to be lower than or equal to the existing inspection algorithm (S126—No), the controller 150 may main the existing inspection algorithm.

As such, according to an embodiment, when performing a vision inspection, the image deviation reflecting the repeated positional errors of the mobile robot is automatically calculated and the vision inspection is performed by generating the inspection algorithm reflecting the same, thereby improving the inspection performance with respect to the repeated positional error of the mobile robot.

In addition, while performing the vision inspection, by generating the new inspection algorithm by designating an augmentation range reflecting an image deviation due to aging of the equipment over time or various environmental changes, and replacing/updating the existing inspection algorithm with the same, degradation of inspection performance can be prevented, and an optimal inspection quality can be maintained.

In addition, the mobile robot can perform vision inspections following the worker and limit its movement so that it does not enter the zone where the worker is currently present, thereby preventing collisions without interfering with the worker's work path.

The exemplary embodiments of the present disclosure described above are not only implemented by the apparatus and the method, but may be implemented by a program for realizing functions corresponding to the configuration of the embodiments of the present disclosure or a recording medium on which the program is recorded.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

1. A vision inspection system utilizing a vision sensor configured to move to at least one designated inspection position P and photograph an inspection region of a component part assembled with a product comprising:
an inspection server configured to obtain an inspection image photographed from a mobile robot, calculate an image deviation of the inspection image compared to a reference image reflecting repeated positional errors of the robot with respect to respective inspection positions, and evaluate an assembly quality of the inspection image for each inspection position through an inspection algorithm learned by performing an image augmentation reflecting a range of the image deviation.

2. The vision inspection system of claim 1, wherein the mobile robot comprises:
a vision sensor module configured to generate the inspection image photographed at the inspection position;
an autonomous driving sensor module configured to detect surroundings through sensors;
a mobile module configured to freely move through drive wheels or quadruped walking;
a wireless communication module configured to transmit the photographed inspection image to the inspection server through a wireless communication; and
a control module configured to perform a control to recognize a position of a worker the vision sensor module, follow the worker to move to the inspection position P where the work has been completed, and photograph the inspection image through the vision sensor module.

3. The vision inspection system of claim 2, wherein:
the control module stores at least one inspection position designated for an assembling position of the component part to be assembled in a corresponding process depending on a type and specifications of the product and photographing an inspection image.

4. The vision inspection system of claim 2, wherein the control module is configured to distinguish a plurality of zones circumferentially partitioned around the product, and restrict movement so as not to enter a worker zone where the worker is currently present.

5. The vision inspection system of claim 2, wherein the vision sensor module is mounted on the mobile robot through a robot arm, and configured to photograph the inspection image of an exterior component part and an interior component part of the product through a motion control of the robot arm.

6. The vision inspection system of claim 1, wherein the inspection server comprises:
a communication unit configured to obtain the inspection image from the mobile robot;
an image processing unit configured to store the reference image corresponding to the inspection image for each component part and generate a correction image converted by match-processing the inspection image by comparison with the reference image;
a deep-learning learning unit configured to construct the inspection algorithm for each inspection component part of a corresponding process by learning the inspection position of a repeated positional error range with respect to each mobile robot by deep-learning through the image augmentation with respect to the inspection image in advance;
a database (DB) configured to store a program and data for operating the inspection server; and
a controller configured to generate a new inspection algorithm by designating an image augmentation range for the deep-learning learning based on a transformation matrix obtained by the image matching processing process.

7. The vision inspection system of claim 6, wherein the image processing unit is configured to extract a transformation matrix information that can be obtained when correcting the inspection image by calculating an image matching error of the inspection image with respect to the reference image and calculating the image deviation between two images at the image matching processing.

8. The vision inspection system of claim 7, wherein the transformation matrix information comprises information on Translation for image moving the image, Rotation for image rotation, Scale for image enlargement/reduction, Tilt for image slope conversion and Shear for image shearing, as values for quantifying the image deviation.

9. The vision inspection system of claim 6, wherein the image processing unit is configured to extract at least one inspection component part image corresponding to a region of inspection component part (ROI) set for the reference image in the correction image as learning data.

10. The vision inspection system of claim 6 wherein the deep-learning learning unit is configured to perform the image augmentation using a transformation matrix range and the inspection component part image extracted by the image processing unit and augment a learning image of the corresponding inspection component part to which the repeated positional error range is reflected.

11. The vision inspection system of claim 10, wherein the deep-learning learning unit is configured to learn the inspection component part image by deep-learning through the inspection algorithm of a corresponding component part, and output one inspection result among good (OK), defective (NG), and inspection error (NA).

12. The vision inspection system of claim 11, wherein the controller is configured to generate the new inspection algorithm reflecting an image augmentation range for the deep-learning learning in real time based on a transformation matrix information obtained by an image matching processing process of an inspection image.

13. The vision inspection system of claim 11, wherein the controller is configured to replace or update the existing inspection algorithm with the new inspection algorithm when it is determined that the performance has been improved by comparing an inspection result learned again by deep-learning using the new inspection algorithm with an inspection result obtained by using an existing inspection algorithm.

14. A vision inspection method utilizing a mobile robot for inspecting manual assembly quality of a worker in real time in a vehicle assembly process, the vision inspection method comprising:
obtaining a photographed inspection image at a specific inspection position where an inspection around a product vehicle is required by using the mobile robot;
extract an inspection component part image from a correction image converted from the inspection image by image matching processing to match a preset reference image;
automatically calculate an image deviation of the inspection image compared to the reference image reflecting repeated positional errors of the robot with respect to respective inspection positions, storing an inspection algorithm learned by performing an image augmentation reflecting a range of the image deviation, and performing the vision inspection by a deep-learning learning using the inspection algorithm for the inspection component part corresponding to the inspection component part image; and
obtaining one inspection result among good (OK), defective (NG), and inspection error (NA) according to the vision inspection.

15. The vision inspection method of claim 14, wherein the obtaining the inspection result further comprise:
extracting images that are falsely inspected or cannot be judged through confirmation of an operator on the inspection result, and storing the extracted images as evaluation data for confirming the performance of a new inspection algorithm, when the inspection result is determined to be defective (NG) or inspection error (NA).

16. The vision inspection method of claim 14, wherein the extracting the inspection component part image further comprises:
generating the new inspection algorithm by designating an image augmentation range for the deep-learning learning based on a transformation matrix obtained by an image matching processing process.

17. The vision inspection method of claim 16, wherein the generate the new inspection algorithm comprises:
calculating an image matching error of the inspection image with respect to the reference image;
extracting the transformation matrix that can be obtained when correcting the inspection image, by calculating the image deviation between two images;
calculate a distribution of transformation matrix values extracted corresponding to the inspection position and store a range in a DB;
designating a transformation matrix range for the image augmentation at the deep-learning learning of the corresponding inspection component part image based on a repeated positional error range stored in the DB; and
deep-learning learning a plurality of learning images augmented be the augmentation in which the repeated positional error of the mobile robot is reflected, generating the new inspection algorithm of a corresponding component part, and re-learning the inspection component part image through deep-learning.

18. The vision inspection method of claim 17, wherein the designating the matrix range designates a range at random number generation of conversion values of the Translation, the Rotation, the Scale, the Tilt, and the Shear of the inspection component part image by using the augmentation at the deep-learning learning based on the repeated positional error range of the transformation matrix.

19. The vision inspection method of claim 18, wherein the designating the matrix range performs the deep-learning learning by generating a random number according to a Gaussian normal distribution and assigning a weight value to the image deviation having a high possibility based on repeated error of the mobile robot depending on positions.

20. The vision inspection method of claim 17, further comprising, after the re-learning by the deep-learning:
replacing or updating an existing inspection algorithm with the new inspection algorithm, when it is determined that the performance is improved by comparing the re-learned result with the evaluation data.
